(19) United States
(12) Patent Application Publication
(10) Pub. No.: US 2007/0246615 A1
(43) Pub. Date: Oct. 25, 2007

(54) Method for connecting pipes of different diameters with a single bracket

(76) Inventors: Malik Maache, Memmelshoffen (FR); Adrien Lehmann, Schleithal (FR); Rolf Engel, Maikammer (DE)

Correspondence Address: MCGRATH, GEISSLER, OLDS & RICHARDSON, PLLC, P.O. BOX 1364, FAIRFAX, VA, 22038-1364, US

(21) Appl. No.: 11/785,856

(22) Filed: Apr. 20, 2007

(30) Foreign Application Priority Data
Apr. 20, 2006 (DE) 102006 018 439.4

(51) Int. Cl. F16L 3/08

(52) U.S. Cl. 248/65

(57) ABSTRACT

A process for connecting pipes of different diameters using a single bracket is provided. The pipes at a point at which the connection with the bracket is to take place are deformed such that the cross section of the pipe fits the bracket. The bracket is designed for the pipe with the smallest diameter.

This nonprovisional application claims priority to German Patent Application No. DE 102006018439, which was filed in Germany on Apr. 20, 2006, and which is herein incorporated by reference.

### BACKGROUND OF THE INVENTION

1. Field of the Invention

The present invention relates to a method for connecting pipe ends of different diameters with a single bracket.

2. Description of the Background Art

In the automotive industry, some vehicle models are equipped with engines of different power ratings. Different engine powers result in different exhaust volumes. Different exhaust volumes mean exhaust systems with different pipe diameters. Since the exhaust pipes are fastened to the vehicle chassis using brackets, different pipe diameters mean different bracket sizes. These brackets must be designed, tested, cataloged, produced, stored, transported, and installed. This entails considerable expense.

Naturally, the experts have sought solutions that make it possible to fasten pipes of different diameters with a single bracket. These brackets have a prismatic opening that receives the pipes. However, such prismatic brackets have drawbacks. First, the contact between bracket and pipe is pointwise. Second, the pipes have different positions depending on their diameter. Such differences in the pipe positions in the engine chamber or beneath the vehicle chassis are not tolerable.

### SUMMARY OF THE INVENTION

It is therefore an object of the present invention to provide a process that makes it possible to connect pipes of different diameters optimally in each case, i.e., two-dimensionally, with a single bracket.

This goal is achieved in that at the site at which the connection with the bracket is to take place, the pipe is deformed so that it fits into the bracket.

The present invention is based on the principle of using a single bracket for all pipe diameters and deforming the respective pipe, at least in the area of the bracket, in such a way that an optimal connection between the bracket and the pipe becomes possible.

Preferably, the pipe is designed for the pipe with the smallest diameter, and the pipes with larger diameters are deformed in certain areas such that they fit into the bracket.

In accordance with a further embodiment of this method, the pipes with larger diameters are deformed such that their pipe center corresponds to the pipe center of the pipe with the smallest diameter. In this way it is ensured that the pipes are always located at the same place.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates a cross section through a bracket with a pipe fastened to it; and

FIG. 2 is an isometric view illustrating a second bracket with a pipe fastened to it.

### DETAILED DESCRIPTION

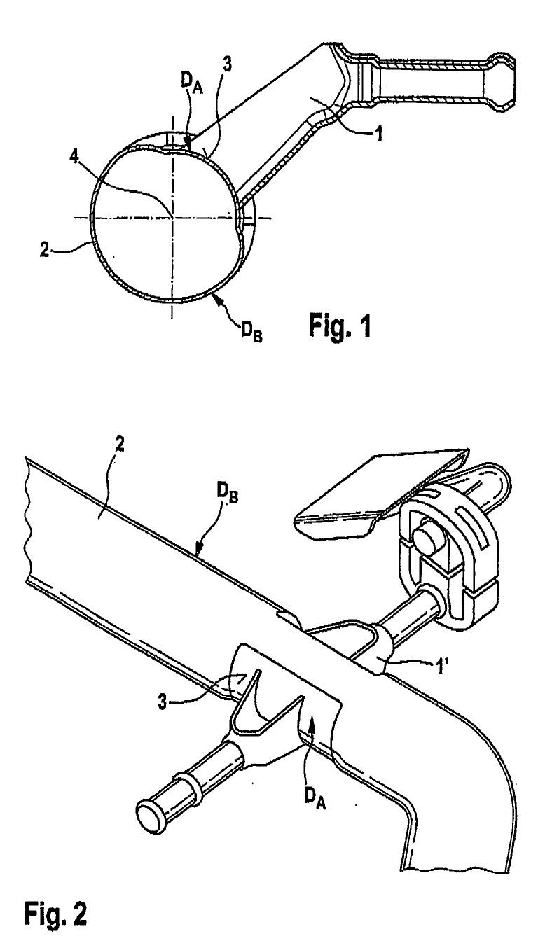

FIG. 1 shows a cross section through a bracket 1 and a pipe 2 fastened to it. The bracket 1 is designed at the connection site 3 with the pipe 2 for a pipe diameter D_{A} that is smaller than the diameter D_{B} of the pipe 2. For this reason, the pipe 2 is deformed in a certain area at the connecting site 3 with the bracket 1 in such a way that the connecting site 3 has substantially the same diameter D_{A}. In this way it is possible to connect the pipe 2 optimally with the bracket 1, i.e., without a gap and with a flat connecting seam.

As FIG. 1 shows, the connecting site 3 of the pipe 2 is deformed such that the center 4 of the pipe 2 always has substantially the same distance from the bracket 1, regardless of the size of the actual pipe diameter D_{B}.

FIG. 2 shows, in isometric representation, a second exemplified embodiment. One can recognize a double bracket 1′, the connecting site 3 of which is designed for the pipe with the smallest diameter D_{A}. The pipe 2, in contrast, has a larger diameter D_{B}. For adaptation to the bracket 1′, the pipe 2 is deformed in the area of the bracket 1′ on both sides in such a way that the connecting site 3 has the radius D_{A} suitable for the bracket 1′.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for fastening pipes of different diameters, the method comprising:
providing a single bracket for fastening the pipes of different diameters; and
deforming the pipe at an area at which the bracket contacts the pipe such that the pipe fits into the bracket.

2. The method according to claim 1, wherein the bracket is designed for the pipe with the smallest diameter and wherein the pipe with a larger diameter is deformed such that it fits into the bracket.

3. The method according to claim 1, wherein the pipe with a larger diameter is deformed such that a pipe center corresponds to a pipe center of the pipe with the smallest diameter.

4. The method according to claim 1, wherein a diameter of the pipe in an area that is not deformed is larger than a diameter of the pipe in the area of deformation.
